(19) United States
(12) Patent Application Publication
(10) Pub. No.: US 2026/0271032 A1
(43) Pub. Date: Sep. 10, 2026

(54) PHYSICAL SIDELINK CONTROL CHANNEL MAPPING FOR INTERLACED RESOURCE BLOCK BASED TRANSMISSION

(71) Applicant: QUALCOMM Incorporated, San Diego, CA (US)

(72) Inventors: Shaozhen GUO, Beijing (CN); Changlong XU, Beijing (CN); Luanxia YANG, Beijing (CN); Siyi CHEN, Beijing (CN); Jing SUN, San Diego, CA (US); Chih-Hao LIU, San Diego, CA (US); Xiaoxia ZHANG, San Diego, CA (US); Hao XU, Beijing (CN)

(21) Appl. No.: 19/473,120

(22) PCT Filed: May 11, 2023
(86) PCT No.: PCT/CN2023/093478

§ 371 Date: Oct. 6, 2025

(51) Int. Cl. H04W 72/25; H04L 5/00

(52) U.S. Cl. CPC H04W 72/25; H04L 5/0094

(57) ABSTRACT

Various aspects of the present disclosure generally relate to wireless communication. In some aspects, a user equipment (UE) may receive an interlace configuration for a sidelink resource pool. The UE may transmit a physical sidelink control channel (PSCCH) communication scheduling a physical sidelink shared channel (PSSCH) communication for transmission in the sidelink resource pool, wherein the PSCCH communication is mapped to a set of resources based on a mapping rule in accordance with the interlace configuration. Numerous other aspects are described.

### FIELD OF THE DISCLOSURE

Aspects of the present disclosure generally relate to wireless communication and to techniques and apparatuses for physical sidelink control channel mapping for interlaced resource block based transmission.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

Some aspects described herein relate to a method of wireless communication performed by a user equipment (UE). The method may include receiving an interlace configuration for a sidelink resource pool. The method may include transmitting a physical sidelink control channel (PSCCH) communication scheduling a physical sidelink shared channel (PSSCH) communication for transmission in the sidelink resource pool, wherein the PSCCH communication is mapped to a set of resources based on a mapping rule in accordance with the interlace configuration.

Other aspects provide: an apparatus operable, configured, or otherwise adapted to perform any one or more of the aforementioned methods and/or those described herein with reference to and as illustrated by the drawings; a non-transitory, computer-readable medium comprising computer-executable instructions that, when executed by a processor of an apparatus, cause the apparatus to perform the aforementioned methods and/or those described herein with reference to and as illustrated by the drawings; a computer program product embodied on a computer-readable storage medium comprising code for performing the aforementioned methods and/or those described herein with reference to and as illustrated by the drawings; and/or an apparatus comprising means for performing the aforementioned methods and/or those described herein with reference to and as illustrated by the drawings. By way of example, an apparatus may comprise a processing system, a device with a processing system, or processing systems cooperating over one or more networks.

The foregoing bas outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network, in accordance with the present disclosure.

FIG. 2 depicts aspects of an example base station (BS) and user equipment (UE), in accordance with the present disclosure.

FIG. 3 depicts an example disaggregated base station architecture, in accordance with the present disclosure.

FIGS. 4A, 4B, 4C, and 4D depict aspects of data structures for a wireless communications network, in accordance with the present disclosure.

FIG. 5 is a diagram illustrating an example of sidelink communications, in accordance with the present disclosure.

FIG. 6 is a diagram illustrating an example of sidelink communications and access link communications, in accordance with the present disclosure.

FIG. 7 is a diagram illustrating an example of a sidelink resource pool using interlacing across two resource block (RB) sets, in accordance with the present disclosure.

FIG. 8 is a diagram illustrating an example of a mapping rule in which the number of interlaces allocated to a physical sidelink control channel (PSCCH) is configured, in accordance with the present disclosure.

FIG. 9 is a diagram illustrating examples of mapping rules for multiple interlaces corresponding to a single subchannel, in accordance with the present disclosure.

FIG. 10 is a diagram illustrating an example of a mapping rule in which the number of interlaces allocated to a PSCCH communication is configured, in accordance with the present disclosure.

FIG. 11 is a diagram illustrating examples of mapping rules for multiple interlaces corresponding to a single subchannel, in accordance with the present disclosure.

FIG. 12 is a diagram illustrating an example of signaling of a number of physical RBs (PRBs) allocated to a PSCCH communication, in accordance with the present disclosure.

FIG. 13 is a diagram illustrating examples of mapping rules for multiple interlaces corresponding to a single subchannel using a configured number of RBs for a PSCCH communication, in accordance with the present disclosure.

FIG. 14 is a diagram illustrating examples of mapping rules for an interlace including fewer PRBs than a configured number of PRBs for a PSCCH communication, in accordance with the present disclosure.

FIG. 15 is a flowchart of an example method of wireless communication, in accordance with the present disclosure.

FIG. 16 is a diagram illustrating an example of an implementation of code and circuitry for a communications device, in accordance with the present disclosure, in accordance with the present disclosure.

### DETAILED DESCRIPTION

Aspects of the present disclosure provide apparatuses, methods, processing systems, and computer-readable mediums for physical sidelink control channel (PSCCH) mapping for interlaced resource block (RB) based transmission.

A group of user equipments (UEs) may communicate on the sidelink using resources defined by a sidelink resource pool. A sidelink resource pool may include a number of RBs in the frequency domain, and may include a number of time resources (e.g., symbols, slots) in the time domain. Some sidelink communications may occur in unlicensed spectrum. In unlicensed spectrum, UEs (or other wireless communication devices) access the spectrum using channel access mechanisms. In unlicensed spectrum, it may be beneficial for a UE's communications to occupy the full bandwidth on which the UE has secured access, thereby reducing inter-carrier interference and improving utilization of the bandwidth. Therefore, sidelink communications in unlicensed spectrum (such as NR-Unlicensed (NR-U)) may use an interlaced waveform, in which different communications, mapped to different subchannels, are interlaced over a frequency bandwidth of a sidelink resource pool.

Sidelink communications include (among other channels) PSCCH communications and physical sidelink shared channel (PSSCH) communications. The PSCCH communication may carry sidelink control information scheduling the PSSCH communication. Ambiguity may arise in how to map the PSCCH communication when using interlacing. For example, the payload size of the PSCCH communication is generally smaller than the payload size of the PSSCH communication, in which case the PSCCH communication may occupy a smaller number of interlaces than the PSSCH communication. Thus the frequency mapping of the PSCCH communication to an interlace may not fully utilize the number of interlaces configured on the channel. Furthermore, it may be unclear how to map the PSCCH frequency resource to the interlaced PSSCH resource associated with a lowest subchannel of the lowest RB set. For example, a given subchannel may be associated with multiple interlace indexes, leading to ambiguity as to which of these interlace indexes should be mapped to first (particularly given that a PSCCH communication may occupy fewer interlaces than a PSSCH communication). This ambiguity may lead to underutilization of radio resources, failure to properly interlace communications, or failure of PSCCH communications. Furthermore, in some examples, a sidelink resource pool may not support a sufficient number of physical resource blocks (PRBs), per interlace, to transmit a PSCCH. For example, a guard band may invalidate one or more PRBs of the interlace. In this situation, ambiguity may arise as to how to map the PSCCH to the interlace, which may cause failure to transmit the PSCCH or reduced efficiency of sidelink resource allocation.

Various aspects relate generally to sidelink resource allocation. Some aspects more specifically relate to mapping a PSCCH to interlaced resources of a sidelink resource pool. In some examples, a UE maps a PSCCH communication to a set of resources of a sidelink resource pool in accordance with a mapping rule. For example, the mapping rule may indicate how to map the PSSCH communication in accordance with an interlace configuration that indicates interlace indexes and subchannels corresponding to the interlace indexes. In some examples, the mapping rule indicates how to map a PSCCH communication when one or more PRBs of a corresponding interlace are unusable, for example, due to a guard band invalidating the one or more PRBs for transmission.

Particular aspects of the subject matter described in this disclosure can be implemented to realize one or more of the following potential advantages. In some examples, by mapping the PSCCH communication in accordance with a mapping rule indicating how to map the PSSCH communication, the described techniques can be used to improve utilization of radio resources, improve interlacing of communications, and reduce the occurrence of failure of PSCCH communications. In some examples, by mapping the PSCCH communication in accordance with the mapping rule indicating how to map a PSCCH communication when one or more PRBs of a corresponding interlace are unusable, the described techniques can be used to reduce occurrence of failure to transmit the PSCCH and to improve efficiency of sidelink resource allocation.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

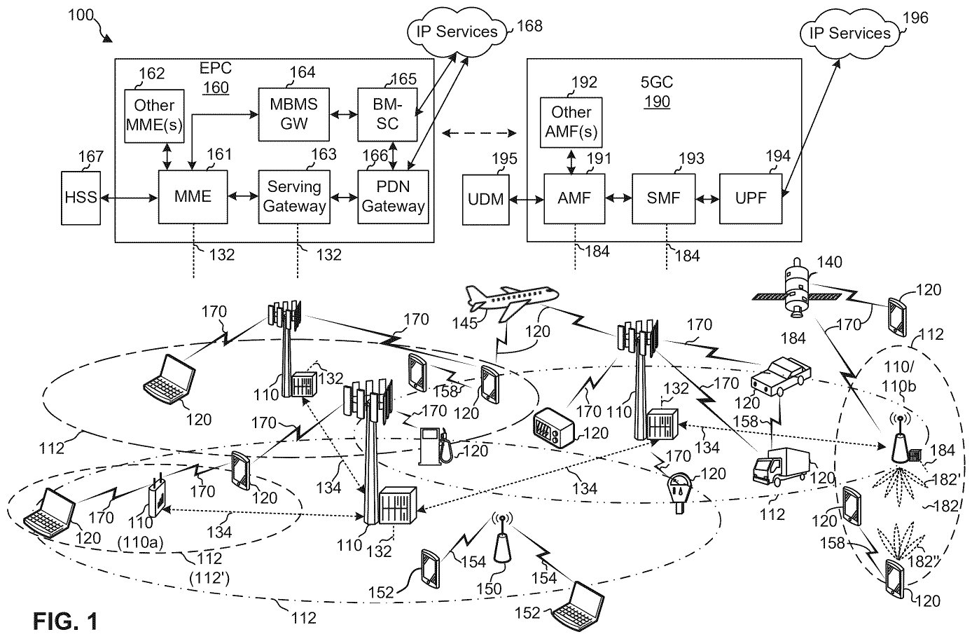

FIG. 1 depicts an example of a wireless communications network 100, in accordance with the present disclosure.

Generally, wireless communications network 100 includes various network entities (alternatively, network elements or network nodes). A network entity is generally a communications device and/or a communications function performed by a communications device (e.g., a UE, a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an internet of things (IoT) device, an always on (AON) device, an edge processing device, or another similar device. A UE 120 may also be referred to as a mobile device, a wireless device, a wireless communication device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

A BS 110 may include, for example, a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS 110 may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

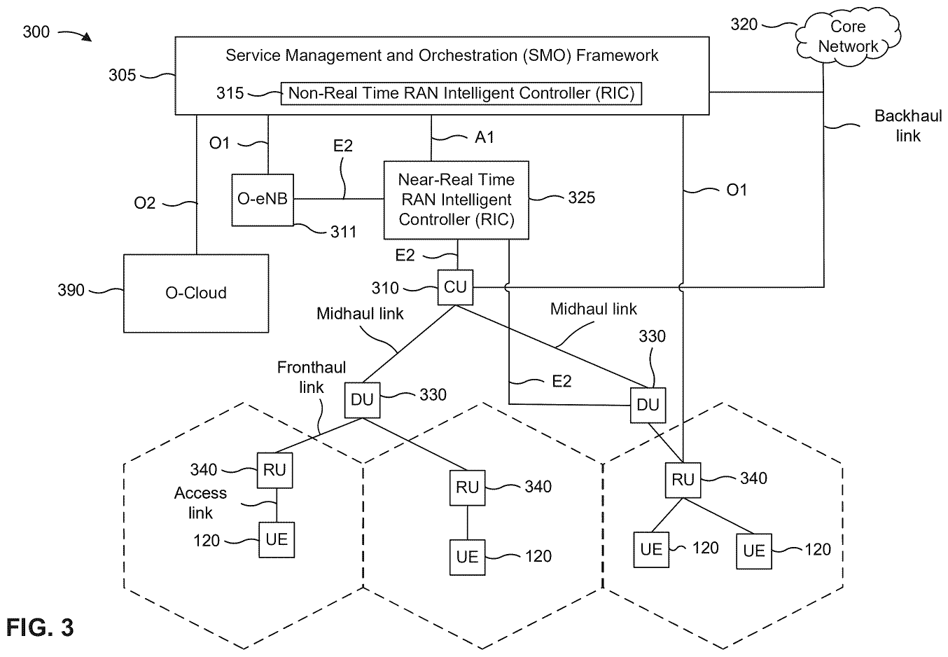

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a BS (e.g., BS 110) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as having a disaggregated radio access network architecture, such as an Open RAN (O-RAN) architecture or a Virtualized RAN (VRAN) architecture. FIG. 3 depicts and describes an example disaggregated BS architecture.

Different BSs 110 within wireless communications network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is based on wavelength and frequency, where frequency may also be referred to as a carrier, a subcarrier, a frequency channel, a tone, or a subband. For example, 3GPP currently defines Frequency Range 1 (FRI) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave or near mmWave radio frequency bands (e.g., a mm Wave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi access point 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a PSSCH, a PSCCH, and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is a control node that processes the signaling between the UEs 120 and the EPC 160. Generally, MME 161 provides bearer and connection management.

Generally, user Internet protocol (IP) packets are transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QoS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, a transmission reception point (TRP), or a combination thereof, to name a few examples.

As indicated above, FIG. 1 is provided as an example. Other examples may differ from what is described with regard to FIG. 1.

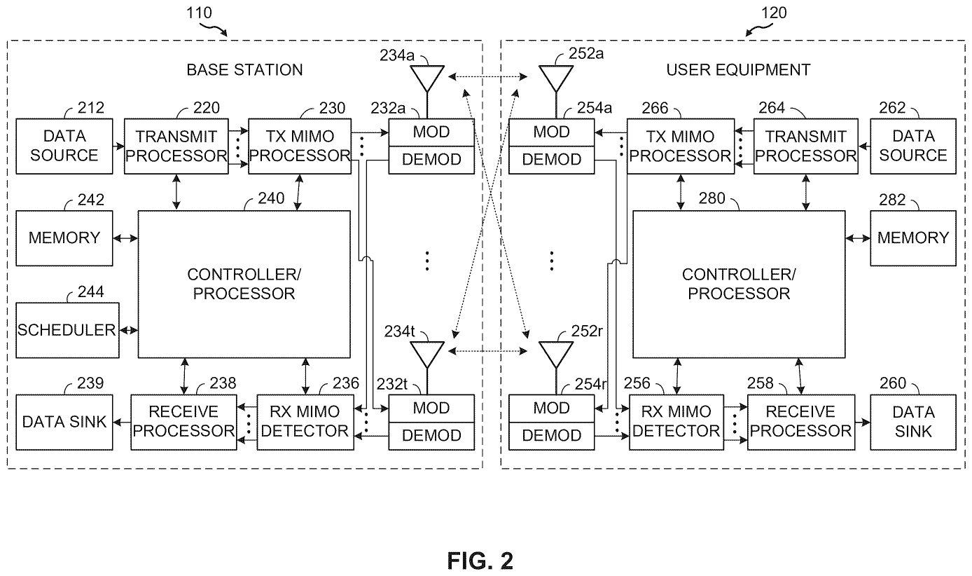

FIG. 2 depicts aspects of an example BS 110 and UE 120, in accordance with the present disclosure.

Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), the physical control format indicator channel (PCFICH), the physical hybrid automatic repeat request (HARQ) indicator channel (PHICH), the physical downlink control channel (PDCCH), the group common PDCCH (GC PDCCH), and/or other channels. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), the secondary synchronization signal (SSS), the PBCH demodulation reference signal (DMRS), or the channel state information reference signal (CSI-RS).

Transmit (TX) MIMO processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

For an example uplink transmission, UE 120 further includes a transmit processor 264 that may receive and process data (e.g., for the physical uplink shared channel (PUSCH)) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 110.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, RX MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data.

In some aspects, a single processor may perform all of the operations described as being performed by the one or more processors. In some aspects, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture. The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an 02 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

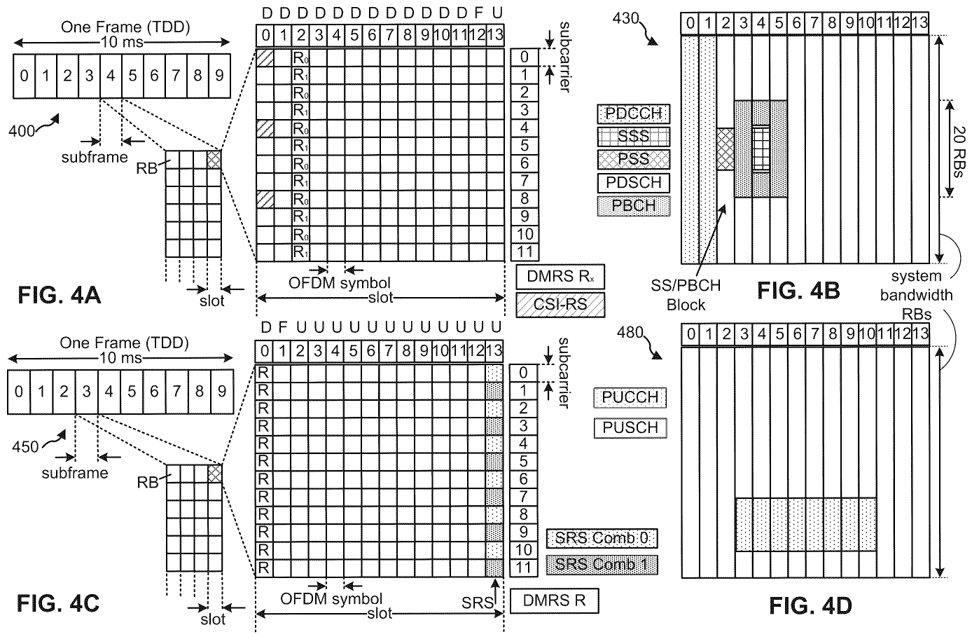

FIGS. 4A, 4B, 4C, and 4D depict aspects of data structures for a wireless communications network, such as wireless communications network 100 of FIG. 1, in accordance with the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be TDD, in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}×15 kHz, where p is the numerology index, which may be selected from values 0 to 5. Accordingly, the numerology μ=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes an RB (also referred to as PRBs) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSs) for a UE (e.g., UE 120). The RSs may include DMRSs and/or CSI-RSs for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The PDCCH carries DCI within one or more control channel elements (CCEs), each CCE including, for example, nine RE groups (REGs), each REG including, for example, four consecutive REs in an OFDM symbol.

A PSS may be within symbol 2 of particular subframes of a frame. The PSS is used by a UE (e.g., UE 120) to determine subframe/symbol timing and a physical layer identity.

An SSS may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The PBCH, which carries a master information block (MIB), may be logically grouped with the PSS and SSS to form a synchronization signal (SS)/PBCH block (SSB). The MIB provides a number of RBs in the system bandwidth and a system frame number (SFN). The PDSCH carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit SRSs. The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

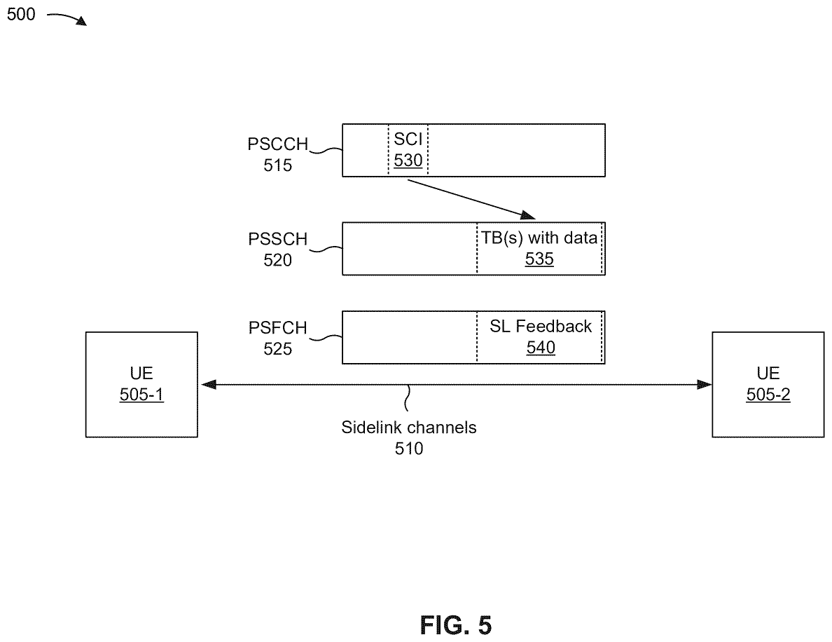

FIG. 5 is a diagram illustrating an example 500 of sidelink communications, in accordance with the present disclosure.

As shown in FIG. 5, a first UE 505-1 may communicate with a second UE 505-2 (and one or more other UEs 505) via one or more sidelink channels 510. The UEs 505-1 and 505-2 may communicate using the one or more sidelink channels 510 for peer-to-peer (P2P) communications, D2D communications, vehicle to anything (V2X) communications (e.g., which may include vehicle-to-vehicle (V2V) communications, vehicle-to-infrastructure (V2I) communications, and/or vehicle-to-pedestrian (V2P) communications) and/or mesh networking. In some aspects, the UEs 505 (e.g., UE 505-1 and/or UE 505-2) may correspond to one or more other UEs described elsewhere herein, such as UE 120. In some aspects, the one or more sidelink channels 510 may use a PC5 interface and/or may operate in a high frequency band (e.g., the 5.9 GHz band). Additionally, or alternatively, the UEs 505 may synchronize timing of transmission time intervals (TTIs) (e.g., frames, subframes, slots, or symbols) using global navigation satellite system (GNSS) timing.

As further shown in FIG. 5, the one or more sidelink channels 510 may include a PSCCH 515, a PSSCH 520, and/or a PSFCH 525. The PSCCH 515 may be used to communicate control information, similar to a PDCCH and/or a PUCCH used for cellular communications with a BS 110 via an access link or an access channel. The PSSCH 520 may be used to communicate data, similar to a PDSCH and/or a PUSCH used for cellular communications with a BS 110 via an access link or an access channel. For example, the PSCCH 515 may carry sidelink control information (SCI) 530, which may indicate various control information used for sidelink communications, such as one or more resources (e.g., time resources, frequency resources, and/or spatial resources) where a transport block (TB) 535 may be carried on the PSSCH 520. The TB 535 may include data. The PSFCH 525 may be used to communicate sidelink feedback 540, such as HARQ feedback (e.g., acknowledgement or negative acknowledgement (ACK/NACK) information), transmit power control (TPC), and/or a scheduling request (SR).

Although shown on the PSCCH 515, in some aspects, the SCI 530 may include multiple communications in different stages, such as a first stage SCI (SCI-1) and a second stage SCI (SCI-2). The SCI-1 may be transmitted on the PSCCH 515. The SCI-2 may be transmitted on the PSSCH 520. The SCI-1 may include, for example, an indication of one or more resources (e.g., time resources, frequency resources, and/or spatial resources) on the PSSCH 520, information for decoding sidelink communications on the PSSCH, a QoS priority value, a resource reservation period, a PSSCH DMRS pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 520, such as a HARQ process ID, a new data indicator (NDI), a source identifier, a destination identifier, and/or a channel state information (CSI) report trigger.

In some aspects, the one or more sidelink channels 510 may use resource pools. For example, a scheduling assignment (e.g., included in SCI 530) may be transmitted in sub-channels using specific RBs across time. In some aspects, data transmissions (e.g., on the PSSCH 520) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 505 may operate using a sidelink transmission mode (e.g., Mode 1) where resource selection and/or scheduling is performed by a BS 110 (e.g., a base station, a CU, or a DU). For example, the UE 505 may receive a grant (e.g., in DCI or in an RRC message, such as for configured grants) from the BS 110 (e.g., directly or via one or more network nodes) for sidelink channel access and/or scheduling. In some aspects, a UE 505 may operate using a transmission mode (e.g., Mode 2) where resource selection and/or scheduling is performed by the UE 505 (e.g., rather than a BS 110). In some aspects, the UE 505 may perform resource selection and/or scheduling by sensing channel availability for transmissions. For example, the UE 505 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 505 may perform resource selection and/or scheduling using SCI 530 received in the PSCCH 515, which may indicate occupied resources and/or channel parameters. Additionally, or alternatively, the UE 505 may perform resource selection and/or scheduling by determining a channel busy ratio (CBR) associated with various sidelink channels, which may be used for rate control (e.g., by indicating a maximum number of resource blocks that the UE 505 can use for a particular set of subframes).

In the transmission mode where resource selection and/or scheduling is performed by a UE 505, the UE 505 may generate sidelink grants, and may transmit the grants in SCI 530. A sidelink grant may indicate, for example, one or more parameters (e.g., transmission parameters) to be used for an upcoming sidelink transmission, such as one or more resource blocks to be used for the upcoming sidelink transmission on the PSSCH 520 (e.g., for TBs 535), one or more subframes to be used for the upcoming sidelink transmission, and/or an MCS to be used for the upcoming sidelink transmission. In some aspects, a UE 505 may generate a sidelink grant that indicates one or more parameters for semi-persistent scheduling (SPS), such as a periodicity of a sidelink transmission. Additionally, or alternatively, the UE 505 may generate a sidelink grant for event-driven scheduling, such as for an on-demand sidelink message.

As indicated above, FIG. 5 is provided as an example. Other examples may differ from what is described with respect to FIG. 5.

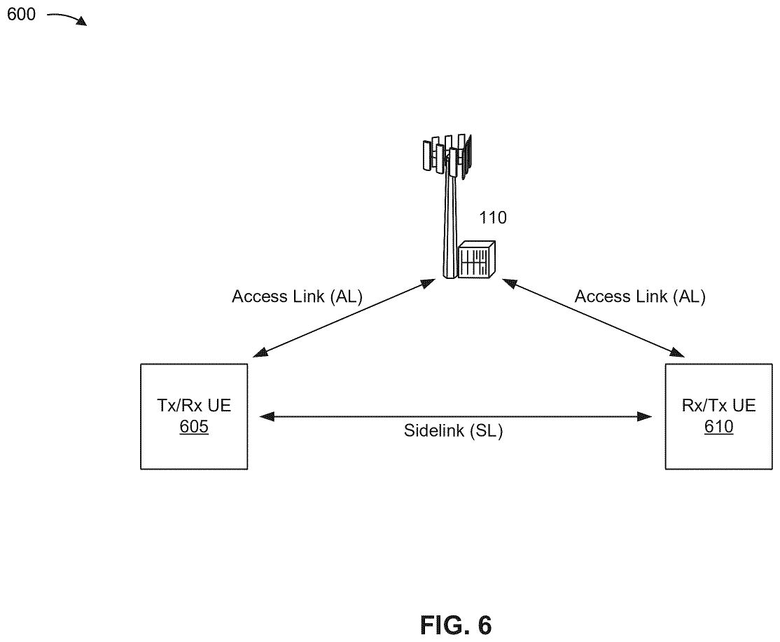

FIG. 6 is a diagram illustrating an example 600 of sidelink communications and access link communications, in accordance with the present disclosure.

As shown in FIG. 6, a transmitter (Tx)/receiver (Rx) UE 605 and an Rx/Tx UE 610 may communicate with one another via a sidelink, as described above in connection with FIG. 5. As further shown, in some sidelink modes, a BS 110 may communicate with the Tx/Rx UE 605 (e.g., directly or via one or more network nodes), such as via a first access link. Additionally, or alternatively, in some sidelink modes, the BS 110 may communicate with the Rx/Tx UE 610 (e.g., directly or via one or more network nodes), such as via a first access link. The Tx/Rx UE 605 and/or the Rx/Tx UE 610 may correspond to one or more UEs described elsewhere herein, such as the UE 120 of FIG. 1. Thus, a direct link between UEs 120 (e.g., via a PC5 interface) may be referred to as a sidelink, and a direct link between a BS 110 and a UE 120 (e.g., via a Uu interface) may be referred to as an access link. Sidelink communications may be transmitted via the sidelink, and access link communications may be transmitted via the access link. An access link communication may be either a downlink communication (from a BS 110 to a UE 120) or an uplink communication (from a UE 120 to a BS 110).

As indicated above, FIG. 6 is provided as an example. Other examples may differ from what is described with respect to FIG. 6.

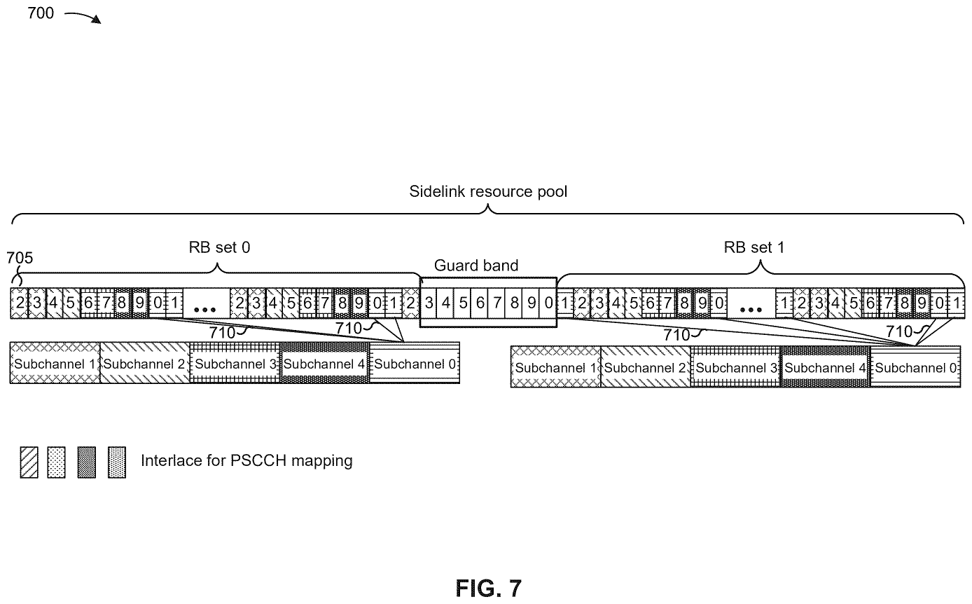

FIG. 7 is a diagram illustrating an example 700 of a sidelink resource pool using interlacing across two RB sets, in accordance with the present disclosure. In FIG. 7, the horizontal axis, with regard to the RB sets 0 and 1, represents frequency. However, the subchannels illustrated in FIG. 7 are not illustrated with regard to any axis, and are shown as mapped to corresponding PRBs of the RB sets 0 and 1 by fill or hatching that matches the corresponding PRBs. The sidelink resource pool may be configured by signaling from a network entity such as a BS 110, a component of a disaggregated BS, or a sidelink network entity such as a controlling UE or a programmable logic controller (PLC). In some aspects, the sidelink resource pool may be associated with sidelink-unlicensed (SL-U) communication. For example, the sidelink resource pool may use a channel access mechanism.

The sidelink resource pool may include a number of RB sets. An RB set may provide available resources (except those within a guard band) within a listen-before-talk (LBT) bandwidth of, for example, 20 MHz. In example 700, the sidelink resource pool includes two RB sets, RB set 0 and RB set 1. Each RB set may include a number of PRBs. “RB” is used interchangeably with “PRB” herein, unless noted otherwise. A UE may be provided a number of symbols in a sidelink resource pool (such as by a parameter sl-TimeResourcePSCCH), starting from a second symbol that is available for sidelink transmissions in a slot, and a number of RBs in the resource pool (such as by a parameter sl-FreqResourcePSCCH), starting from the lowest PRB of the lowest sub-channel of the associated PSSCH communication, for a PSCCH communication with a SCI format 1-A. The sidelink resource pool of example 700 may be used for communication between sidelink UEs, such as using SL-U communication techniques. The communication may include, for example, a first-stage SCI transmission (such as using SCI Format 1-A) on a PSCCH communication, or a PSSCH communication scheduled by the first-stage SCI transmission. For example, the PSCCH communication and the PSSCH communication may be mapped to the PRBs of the sidelink resource pool. In some aspects, the PSCCH communication may be transmitted within a single subchannel (e.g., only one subchannel), whereas the PSSCH communication may be transmitted in one or more subchannels. The parameters described above are helpful for identifying a location of the PSSCH communication relative to a location of the PSCCH communication, which reduces decoding (e.g., blind decoding) complexity at a receiving UE. In some examples, the PSCCH communication may be located in a lowest subchannel of a lowest RB set of a corresponding PSSCH communication. For example, if the PSSCH communication is transmitted (at least partially) in two RB sets and two subchannels, the PSCCH communication may be located in a lowest subchannel (in frequency) of a lowest RB set (in frequency) of the two RB sets and the two subchannels. Additionally, or alternatively, the PSCCH communication may be located in every RB set of the corresponding PSSCH communication.

Each PRB of the sidelink resource pool is associated with an interlace index. The interlace index reoccurs cyclically across the sidelink resource pool. Thus, multiple PRBs may be associated with the same interlace index. In some aspects, the interlace index may be derived relative to a reference point, such as Point A, which is a common reference point for all resource grids in the frequency domain (e.g., a center of subcarrier 0 of a common resource block 0 of a lowest resource grid). Thus, in example 700, the interlace indexes of the sidelink resource pool start at 2, for a lowest PRB (in frequency) of the RB set 0, as shown by reference number 705. As shown by the corresponding hatching or fill, interlace indexes 0 and 1 correspond to subchannel 0, interlace indexes 2 and 3 correspond to subchannel 1, interlace indexes 4 and 5 correspond to subchannel 2, interlace indexes 6 and 7 correspond to subchannel 3, interlace indexes 8 and 9 correspond to subchannel 4. A reference to a communication being mapped to “an interlace index” means that the communication is mapped to RBs corresponding to the interlace index. The group of RBs corresponding to a given interlace index may be referred to as an interlace. Thus, a communication mapped to an interlace may be mapped to a group of RBs corresponding to an interlace index of the interlace.

A subchannel may be mapped to a number of interlace indexes, denoted as K interlace indexes. K can be equal to or greater than 1. For example, for interlace RB-based PSCCH or PSSCH transmission in SL-U, at least K=1 and K=2 may be supported for a 15 kHz subcarrier spacing (SCS), and at least K=1 may be supported for a 30 kHz SCS. In example 700, K=2 since each subchannel is mapped to two interlace indexes. A given subchannel (e.g., with a given index) may be mapped to K interlace(s) with the same index(s) in different RB sets. For example, as shown by reference number 710, subchannel 0 is mapped to interlace indexes 0 and 1. It can further be seen that a given subchannel (e.g., subchannel 0) is defined and indexed within an RB set, and is periodically indexed across different RB sets within the sidelink resource pool. In some examples, a first subchannel (e.g., subchannel #0) is mapped to K interlace(s) starting from interlace #0, a second subchannel (e.g., subchannel #1) is mapped to K interlace(s) starting from interlace #K, and so on. The above K interlace(s) may be contiguous, in some examples.

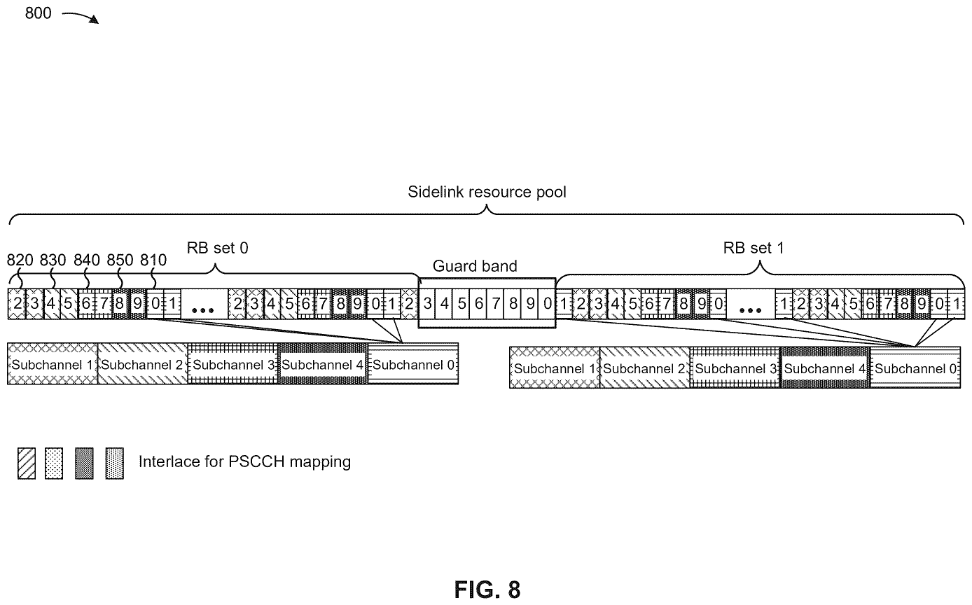

Even if the PSCCH communication is mapped to the lowest subchannel of the lowest RB set of the corresponding PSSCH communication, ambiguity may arise in how to map the PSCCH communication when using interlacing. For example, the payload size of the PSCCH communication is generally smaller than the payload size of the PSSCH communication, in which case the PSCCH communication may occupy a smaller number of interlaces than the PSSCH communication. Thus the frequency mapping of the PSCCH communication to an interlace may be different from the configured K value of the subchannel. Furthermore, it may be unclear how to map the PSCCH frequency resource to the interlaced PSSCH resource associated with the lowest subchannel of the lowest RB set. For example, a given subchannel may be associated with multiple interlace indexes, leading to ambiguity as to which of these interlace indexes should be mapped to first (particularly given that a PSCCH communication may occupy fewer interlaces than a PSSCH communication). This ambiguity may lead to underutilization of radio resources, failure to properly interlace communications, or failure of PSCCH communications. Some techniques described herein provide mapping of a PSCCH communication to resources of a sidelink resource pool according to a mapping rule, described with regard to FIGS. 8-14.

As indicated above, FIG. 7 is provided as an example. Other examples may differ from what is described with regard to FIG. 7.

FIG. 8 is a diagram illustrating an example 800 of a mapping rule in which the number of interlaces allocated to a PSCCH is configured, in accordance with the present disclosure. A sidelink resource pool illustrated in FIG. 8 may be similar to the sidelink resource pool described with regard to FIG. 7. For example, K may be equal to 2, and there may be two RB sets separated by a guard band. The sidelink resource pool may be configured via configuration information, which may include an interlace configuration that indicates one or more parameters defining the interlace, such as K.

FIG. 8 illustrates how a PSCCH communication may be mapped to PRBs of the sidelink resource pool based at least in part on a mapping rule. In some aspects, the mapping rule may indicate that a PSCCH communication is mapped to a lowest subchannel (or if there is only one subchannel, to the subchannel) of a lowest RB set (or if there is only one RB set, to the RB set) of a corresponding PSSCH communication starting at a lowest interlace index (or if there is only one interlace index, starting at the interlace index) corresponding to the lowest subchannel. The corresponding PSSCH communication may be a PSSCH scheduled by SCI carried by the PSCCH communication. The lowest subchannel of the lowest RB set of the corresponding PSSCH communication may be a lowest subchannel (in terms of subchannel index) of one or more subchannels in which the PSSCH communication is scheduled. The lowest subchannel may be mapped to one or more RB sets. The lowest RB set may be a lowest RB set in frequency. For example, RB set 0 is lower than RB set 1. The lowest interlace index may be defined in terms of the interlace index. For example, interlace index 5 is lower than interlace index 9. The lowest interlace index, for each subchannel of FIG. 8, is shown by reference number 810 (for Subchannel 0), reference number 820 (for Subchannel 1), reference number 830 (for Subchannel 2), reference number 840 (for Subchannel 3), and reference number 850 (for Subchannel 4). While the PSCCH communication is mapped to each PRB belonging to a given interlace, each of these reference numbers is shown only once for clarity.

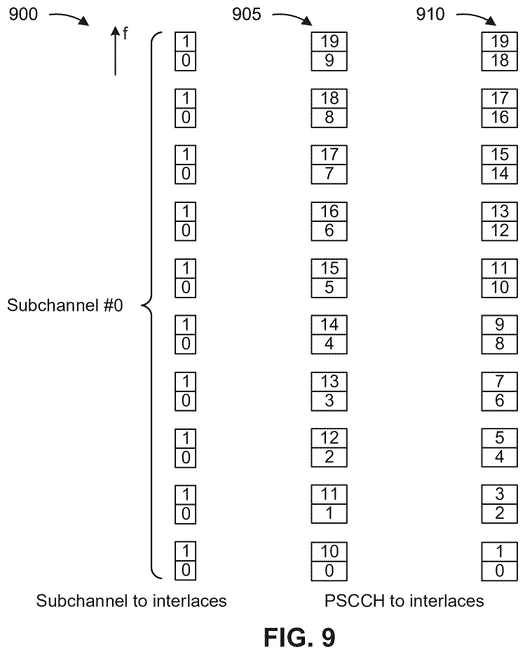

As an example, if I interlace is configured for the PSCCH communication and the PSCCH communication is transmitted in Subchannel 0 (assuming subchannel 0 is the lowest subchannel of the lowest RB set where PSSCH is scheduled), the PSCCH communication may be mapped to interlace 0 (that is, a lowest interlace index) of Subchannel 0. As another example, the PSCCH communication may be mapped to multiple interlace indexes of the lowest subchannel (e.g., N interlaces, where N & K). In this example, in some aspects, the PSCCH communication may be mapped to the PRBs according to an increasing order of PRB index of the same interlace, then according to an increasing order of interlace index. Alternatively, the PSCCH communication may be mapped to multiple interlaces according to an increasing order of PRB index across all interlaces. Examples of these mapping rules are provided in FIG. 9.

As indicated above, FIG. 8 is provided as an example. Other examples may differ from what is described with regard to FIG. 8.

FIG. 9 is a diagram illustrating examples of mapping rules for multiple interlaces corresponding to a single subchannel, in accordance with the present disclosure. Reference number 900 shows interlace indexes of PRBs corresponding to a subchannel #0. With regard to reference number 900, for example, “0” indicates interlace index 0. It can be seen that interlace indexes 0 and I correspond to subchannel #0, as in FIGS. 7 and 8. Reference numbers 905 and 910 illustrate an order in which a PSCCH communication is mapped to PRBs corresponding to interlace indexes 0 and 1. For example, “0” indicates a first PRB to which the PSCCH communication is mapped, and “9” indicates a tenth PRB to which the PSCCH communication is mapped. In FIG. 9, the vertical axis represents frequency, with frequency increasing in the upward direction.

Reference number 905 shows a mapping rule in which a PSCCH communication may be mapped to the PRBs according to an increasing order of PRB index of the same interlace, then according to an increasing order of interlace index. For example, the mapping rule may indicate to map the PSCCH communication to increasing PRB indexes of a first interlace index of the multiple interlace indexes, and then to map the PSCCH communication to increasing PRB indexes of a second interlace index after mapping the PSCCH communication to the increasing PRB indexes of the first interlace index, wherein the second interlace index is larger than the first interlace index. PRB indexes may increase as frequency increases. Thus, the PSCCH communication is first mapped to each PRB belonging to interlace index 0, then to each PRB belonging to interlace index 1.

Reference number 910 shows a mapping rule in which a PSCCH communication may be mapped to multiple interlaces according to an increasing order of PRB index across all interlaces. For example, the UE may map the PSCCH communication to increasing PRB indexes across all PRBs corresponding to the multiple interlace indexes. In this example, “all PRBs” may include PRBs corresponding to interlace index 0 and all PRBs corresponding to interlace index 1. Mapping to increasing PRB indexes across all PRBs corresponding to the multiple interlace indexes may include mapping to a first PRB associated with a lowest PRB index (irrespective of whether the first PRB belongs to the first interlace index or the second interlace index, so long as the first PRB belongs to one of the first interlace index or the second interlace index), then to a second PRB associated with a second-lowest PRB index (irrespective of whether the first PRB belongs to the first interlace index or the second interlace index, so long as the first PRB belongs to one of the first interlace index or the second interlace index), and so on.

As indicated above, FIG. 9 is provided as an example. Other examples may differ from what is described with regard to FIG. 9.

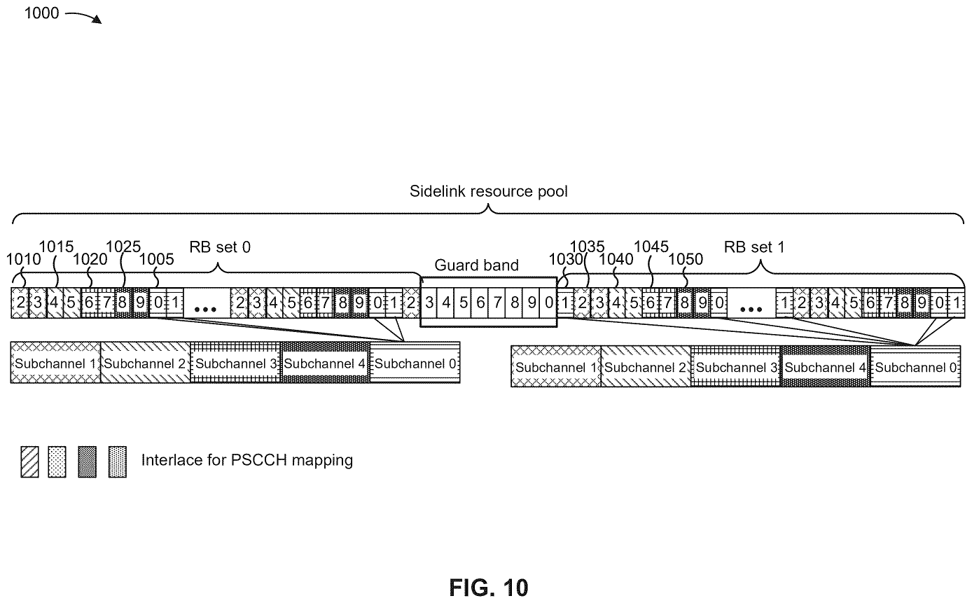

FIG. 10 is a diagram illustrating an example 1000 of a mapping rule in which the number of interlaces allocated to a PSCCH communication is configured, in accordance with the present disclosure. A sidelink resource pool illustrated in FIG. 10 may be similar to the sidelink resource pool described with regard to FIG. 7. For example, K may be equal to 2, and there may be two RB sets separated by a guard band. The sidelink resource pool may be configured via configuration information, which may include an interlace configuration that indicates one or more parameters defining the interlace, such as K.

FIG. 10 illustrates how a PSCCH communication may be mapped to PRBs of the sidelink resource pool based at least in part on a mapping rule. In some aspects, the mapping rule may indicate that a PSCCH communication is mapped to a lowest subchannel (or if there is only one subchannel, to the subchannel) of a lowest RB set (or if there is only one RB set, to the RB set) of a corresponding PSSCH communication starting at an interlace index corresponding to a lowest PRB of the lowest subchannel. The corresponding PSSCH communication may be a PSSCH communication scheduled by SCI carried by the PSCCH communication. The lowest subchannel of the lowest RB set of the corresponding PSSCH communication may be a lowest subchannel (in terms of subchannel index) of one or more subchannels in which the PSSCH communication is scheduled. The lowest subchannel may be mapped to one or more RB sets. The lowest RB set may be a lowest RB set in frequency. For example, RB set 0 is lower than RB set 1.

Example 1000 differs from example 800 in that, in example 1000, the interlace index of the lowest PRB of the lowest subchannel is the first interlace index to which the PSCCH communication is mapped. For example, the interlace index of the lowest PRB of the lowest subchannel may not be the lowest interlace index of the lowest subchannel. The interlace index corresponding to the lowest PRBs of the lowest subchannel of the RB set in which the PSSCH communication is scheduled, for each subchannel of FIG. 10, is shown by reference number 1005 (for Subchannel 0 and RB set 0), reference number 1010 (for Subchannel 1 and RB set 0), reference number 1015 (for Subchannel 2 and RB set 0), reference number 1020 (for Subchannel 3 and RB set 0), reference number 1025 (for Subchannel 4 and RB set 0), reference number 1030 (for Subchannel 0 and RB set 1), reference number 1035 (for Subchannel 1 and RB set 1), reference number 1040 (for Subchannel 2 and RB set 1), reference number 1045 (for Subchannel 3 and RB set 1), and reference number 1050 (for Subchannel 4 and RB set 1). Note that the lowest PRB of the lowest subchannel can differ between different RB sets.

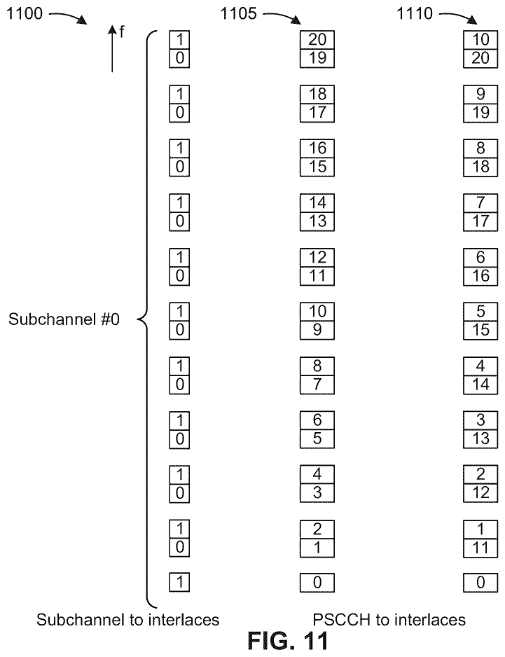

As an example, if 1 interlace is configured for the PSCCH communication and the PSCCH communication is transmitted in Subchannel 0 of RB set 0 (assuming subchannel 0 is the lowest subchannel of the lowest RB set where PSSCH is scheduled), the PSCCH communication may be mapped to interlace 0 (that is, an interlace index corresponding to a lowest PRB of subchannel 0 of RB set 0). If 1 interlace is configured for the PSCCH communication and the PSCCH communication is transmitted in Subchannel 0 of RB set 1 (assuming subchannel 1 is the lowest subchannel of the lowest RB set where PSSCH is scheduled), the PSCCH communication may be mapped to interlace 1 (that is, an interlace index corresponding to a lowest PRB of subchannel 0 of RB set 1). As another example, the PSCCH communication may be mapped to multiple interlace indexes of the lowest subchannel (e.g., N interlaces, where N & K). In this example, in some aspects, the PSCCH communication may be mapped to multiple interlaces according to an increasing order of PRB index across the multiple interlaces. Alternatively, the PSCCH communication may be mapped to multiple interlaces according to increasing PRB indexes of the same interlace, and then according to an increasing order of the starting PRB index of each interlace. Examples of these mapping rules are provided in FIG. 11.

As indicated above, FIG. 10 is provided as an example. Other examples may differ from what is described with regard to FIG. 10.

FIG. 11 is a diagram illustrating examples of mapping rules for multiple interlaces corresponding to a single subchannel, in accordance with the present disclosure. Reference number 1100 shows interlace indexes of PRBs corresponding to a subchannel #0 of an RB set 1 (illustrated in FIG. 10). With regard to reference number 1100, for example, “0” indicates interlace index 0. It can be seen that interlace indexes 0 and 1 correspond to subchannel #0, as in FIG. 10. Reference numbers 1105 and 1110 illustrate an order in which a PSCCH communication is mapped to PRBs corresponding to interlace indexes 0 and 1. For example, “0” indicates a first PRB to which the PSCCH communication is mapped, and “9” indicates a tenth PRB to which the PSCCH communication is mapped. In FIG. 11, the vertical axis represents frequency, with frequency increasing in the upward direction. FIG. 11 differs from FIG. 10 at least in that a lowest RB index corresponds to interlace index 1.

Reference number 1105 shows a mapping rule in which a PSCCH communication may be mapped to multiple interlaces according to an increasing order of PRB index across the multiple interlaces. For example, the mapping rule May indicate to map the PSCCH communication to increasing PRB indexes across all PRBs corresponding to the multiple interlace indexes. PRB indexes may increase as frequency increases. Mapping to increasing PRB indexes across all PRBs corresponding to the multiple interlace indexes may include mapping to a first PRB associated with a lowest PRB index (irrespective of whether the first PRB belongs to the first interlace index or the second interlace index, so long as the first PRB belongs to one of the first interlace index or the second interlace index), then to a second PRB associated with a second-lowest PRB index (irrespective of whether the first PRB belongs to the first interlace index or the second interlace index, so long as the first PRB belongs to one of the first interlace index or the second interlace index), and so on.

Reference number 1110 shows a mapping rule in which a PSCCH communication may be mapped to multiple interlaces according to increasing PRB indexes of the same interlace, and then according to an increasing order of the starting PRB index of each interlace. For example, the UE may map the PSCCH communication to increasing PRB indexes of a first interlace index of the multiple interlace indexes, where the first interlace index is associated with a first starting PRB index. The UE may then map the PSCCH communication to increasing PRB indexes of a second interlace index of the multiple interlace indexes after mapping the PSCCH communication to the increasing PRB indexes of the first interlace index, wherein the second interlace index is associated with a second PRB index that is larger than the first starting PRB index. Thus, the UE may first map the PSCCH communication to increasing PRB indexes associated with interlace index 1, then may map the PSCCH communication to increasing PRB indexes associated with interlace index 0.

As indicated above, FIG. 11 is provided as an example. Other examples may differ from what is described with regard to FIG. 11.

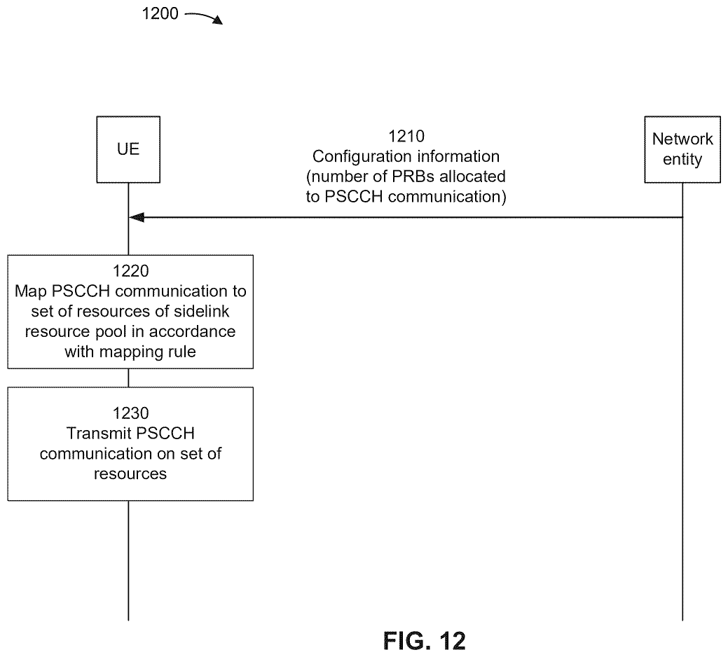

FIG. 12 is a diagram illustrating an example 1200 of signaling of a number of PRBs allocated to a PSCCH communication, in accordance with the present disclosure. Example 1200 includes a UE (e.g., UE 120, UE 505, UE 605) and a network entity (e.g., BS 110 or a component of a disaggregated BS).

As shown by reference number 1210, the network entity may transmit, and the UE may receive, configuration information. In some aspects, the configuration information may define a sidelink resource pool, as described with regard to FIG. 7. In some aspects, the sidelink resource pool may be associated with unlicensed spectrum (e.g., NR-U). In some aspects, the configuration information may include an interlace configuration defining one or more parameters relating to transmission of a PSCCH communication. For example, the interlace configuration may indicate a number of PRBs allocated to the PSCCH communication (e.g., a frequency resource size of the PSCCH communication). In this example, a parameter (e.g., sl-FreqResourcePSCCH) may be used to configure the number of PRBs allocated to the PSCCH communication.

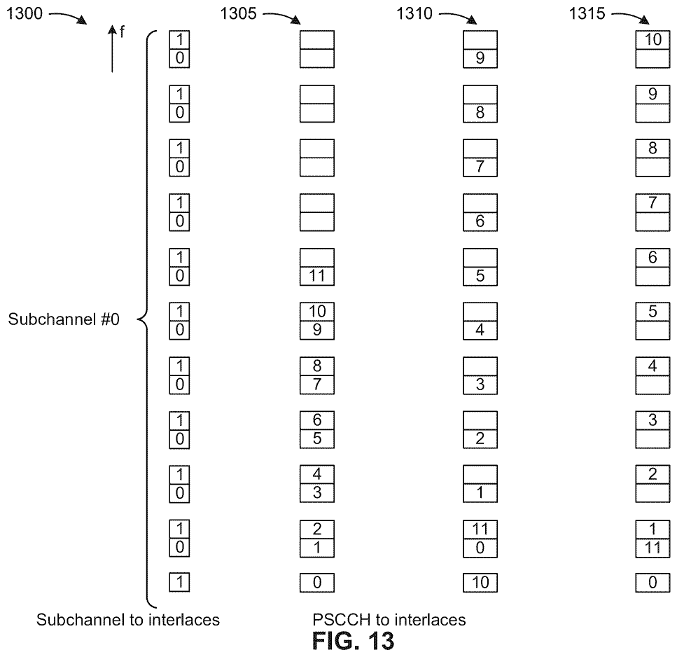

As shown by reference number 1220, the UE may map the PSCCH communication to a set of resources of the sidelink resource pool. For example, the UE may map the number of PRBs of the PSCCH communication to a set of resources of the sidelink resource pool in accordance with a mapping rule. Examples of mapping the PSCCH communication to the set of resources of the sidelink resource pool according to the mapping rule are provided in FIG. 13.

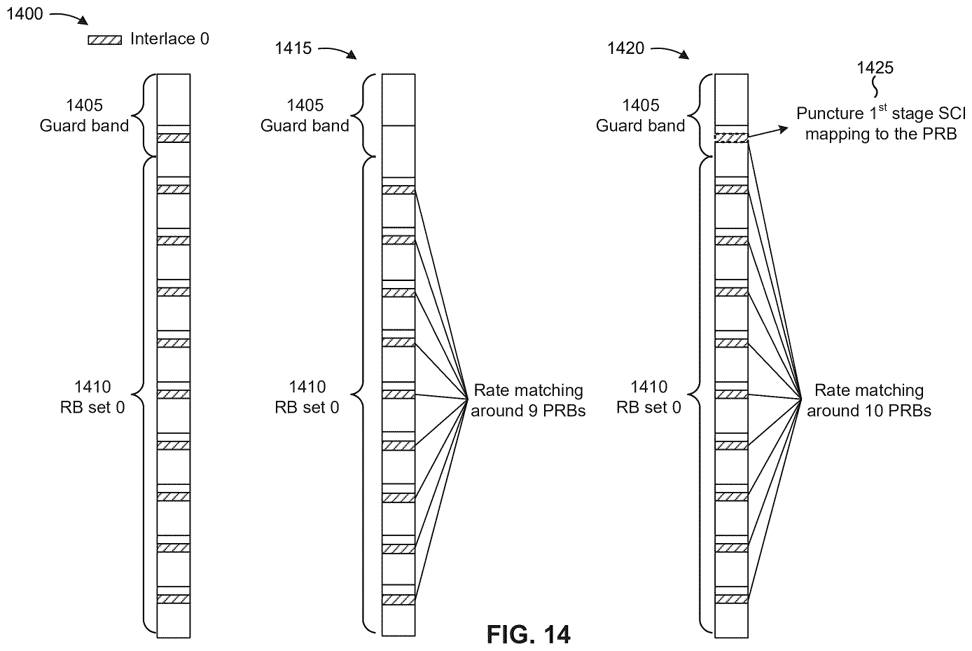

In some cases, depending on a configuration of a guard band of the sidelink resource pool, the number of PRBs included in one interlace may be less than 10 RBs. However, the minimum number of PRBs allocated to the PSSCH communication may be 10 RBs. In this case, ambiguity may arise as to how (or whether) to map the PSSCH communication to the interlace having fewer PRBs than the number of PRBs configured for the PSCCH communication. Some techniques described herein resolve this ambiguity, by providing a mapping rule that indicates whether or how the UE is to map the PSCCH communication to an interlace having fewer PRBs than the number of PRBs configured for the PSCCH communication. In some aspects, the UE may transmit the PSCCH communication only if an interlace to which the PSCCH communication is mapped can support at least the number of RBs allocated to the PSCCH communication. For example, if the frequency resource size configured for the PSCCH communication is 10 PRBs for 1 interlace, the UE may not be allowed to transmit the PSCCH communication in any interlace that has less than 10 PRBs. In some other aspects, the UE may map the PSCCH communication to an interlace having fewer PRBs than the number of PRBs configured for the PSCCH communication, such as using rate matching or puncturing, as described in connection with FIG. 14.

As shown by reference number 1230, the UE may transmit the PSCCH communication. For example, the UE may transmit the PSCCH communication to a second UE (e.g., via a sidelink). The UE may transmit the PSCCH communication on the set of resources (e.g., interlaced PRBs) to which the PSCCH communication was mapped. The UE may additionally transmit a PSSCH communication scheduled by the PSCCH communication.

As indicated above, FIG. 12 is provided as an example. Other examples may differ from what is described with regard to FIG. 12.

FIG. 13 is a diagram illustrating examples of mapping rules for multiple interlaces corresponding to a single subchannel using a configured number of RBs for a PSCCH communication, in accordance with the present disclosure. Reference number 1300 shows interlace indexes of PRBs corresponding to a subchannel #0 of an RB set 1 (illustrated in FIG. 10). With regard to reference number 1300, for example, “0” indicates interlace index 0. It can be seen that interlace indexes 0 and 1 correspond to subchannel #0. Reference numbers 1305, 1310, and 1315 illustrate an order in which a PSCCH communication is mapped to PRBs corresponding to interlace indexes 0 and 1. For example, “0” indicates a first PRB to which the PSCCH communication is mapped, and “9” indicates a tenth PRB to which the PSCCH communication is mapped. A blank rectangle, including no number, indicates that the PSCCH communication is not mapped to the corresponding PRB. In FIG. 13, the vertical axis represents frequency, with frequency increasing in the upward direction. In FIG. 13, 12 PRBs are allocated to the PSCCH communication, such as according to configuration information indicated by reference number 1210 of FIG. 12.

Reference number 1305 shows an example where the PSCCH communication is mapped (according to a mapping rule) to the lowest subchannel of the lowest RB set of the corresponding PSSCH starting from the lowest PRB of the lowest subchannel. In this example, the PSCCH communication is mapped to the multiple PRBs of the lowest subchannel according to ascending order of the PRB index. For example, the UE may map the number of PRBs of the PSCCH communication to increasing PRB indexes corresponding to a subchannel (e.g., a lowest subchannel if the PSSCH communication is scheduled in multiple subchannels) of one or more subchannels in which the PSSCH communication is scheduled starting from the lowest PRB index of the subchannel. Thus, the PSCCH communication is first mapped to a lowest PRB index (corresponding to a lowest frequency) of the subchannel, then to a next-lowest PRB index, and so on.

Reference number 1310 shows an example where the PSCCH communication is mapped (according to a mapping rule) to the lowest subchannel of the lowest RB set of the corresponding PSSCH communication starting from the lowest interlace index of the lowest subchannel. The PSCCH communication is first mapped to the PRBs of a first interlace associated with a lower interlace index, and then mapped to the PRBs of an interlace associated with a higher interlace index. For example, the UE may first map the number of PRBs of the PSCCH communication to increasing PRB indexes of a first interlace index and then may map a remainder of the number of PRBs of the PSCCH communication to increasing PRB indexes of a second interlace index, wherein the second interlace index is larger than the first interlace index. Within the same interlace index, the PSCCH communication is mapped according to increasing RB indexes.

Reference number 1315 shows an example where the PSCCH communication is mapped (according to a mapping rule) to the lowest subchannel of the lowest RB set of corresponding PSSCH starting from the interlace associated with lowest starting PRB. In this example, the PSCCH communication is first mapped to the PRBs of the interlace associated with a lower starting PRB index and then mapped to the PRBs of the interlace associated with a higher starting PRB index. Within the same interlace, the PSCCH communication is mapped according to an increasing order of the PRB index. For example, the UE may first map the number of PRBs of the PSCCH communication to increasing RB indexes of a first interlace index associated with a lower starting PRB index (in this example, interlace index 1) and then may map a remainder of the number of RBs PSCCH communication to a second interlace index associated with a next higher starting RB index (in this example, interlace index 2) that corresponds to the subchannel.

As indicated above, FIG. 13 is provided as an example. Other examples may differ from what is described with regard to FIG. 13.

FIG. 14 is a diagram illustrating examples of mapping rules for an interlace including fewer PRBs than a configured number of PRBs for a PSCCH communication, in accordance with the present disclosure. Example 1400 illustrates a guard band 1405, an RB set 1410 (e.g., RB set 0), and a single interlace (interlace 0). PRBs belonging to the single interlace are illustrated with a diagonal fill. The single interlace nominally includes 10 PRBs. However, one of the 10 PRBs occurs in the guard band 1405, meaning that the PRB in the guard band 1405 cannot be used for transmission of a PSCCH communication. A guard band is a set of frequency resources that provide separation between resources used for transmission. For example, no transmission or reception may occur on resources included in a guard band such as the guard band 1405.

Reference number 1415 shows an example where a UE performs rate-matching for a PSCCH communication (e.g., carrying first stage SCI) according to an actual number of PRBs included in an interlace. For example, the single interlace of the RB set 1410 includes 9 PRBs that are actually usable for transmission (e.g., not included in a guard band or otherwise invalidated for mapping). If the single interlace of the RB set 1410 is used for PSCCH transmission, the UE may perform rate-matching around the 9 actually usable PRBs. “Rate-matching” refers to adjusting the data rate of a communication such that the communication can be mapped to a given number of resources. For example, the UE may rate match the PSCCH communication (e.g., the first stage SCI) from a first data rate that provides for the PSCCH communication to be mapped to 10 PRBs, to a second data rate that provides for the PSCCH communication to be mapped to 9 PRBs. This may improve reliability of the PSCCH communication relative to puncturing the PSCCH communication.

Reference number 1420 shows an example where a UE performs rate-matching for a PSCCH communication (e.g., carrying first stage SCI) according to a nominal number of PRBs included in an interlace. The UE may then puncture the PSCCH communication (e.g., the first stage SCI) in a PRB overlapping a guard band (as shown by reference number 1425) if the actual number of PRBs of the interlace (omitting any PRBs overlapping the guard band) is less than the nominal number of PRBs. For example, the single interlace of the RB set 1410 includes 10 nominal PRBs and 9 PRBs that are actually usable for transmission. If the single interlace of the RB set 1410 is used for PSCCH transmission, the UE may perform rate-matching around the 10 nominal PRBs. The UE may then puncture a portion of the PSCCH communication (e.g., the first stage SCI) mapped to any PRB that overlaps the guard band or is otherwise unusable for transmission. For example, assuming interlace 0 of RB set 0 includes 9 PRBs outside a guard band and interlace 0 of RB set 0 is used for PSCCH transmission, the UE may perform rate-matching around 10 PRBs and then puncture the first stage SCI mapped to the PRB overlapping with guard band. Puncturing may lose some coded bits for 1^{st} stage SCI and may be simpler to implement than rate matching according to actual RBs.

As indicated above, FIG. 14 is provided as an example. Other examples may differ from what is described with regard to FIG. 14.

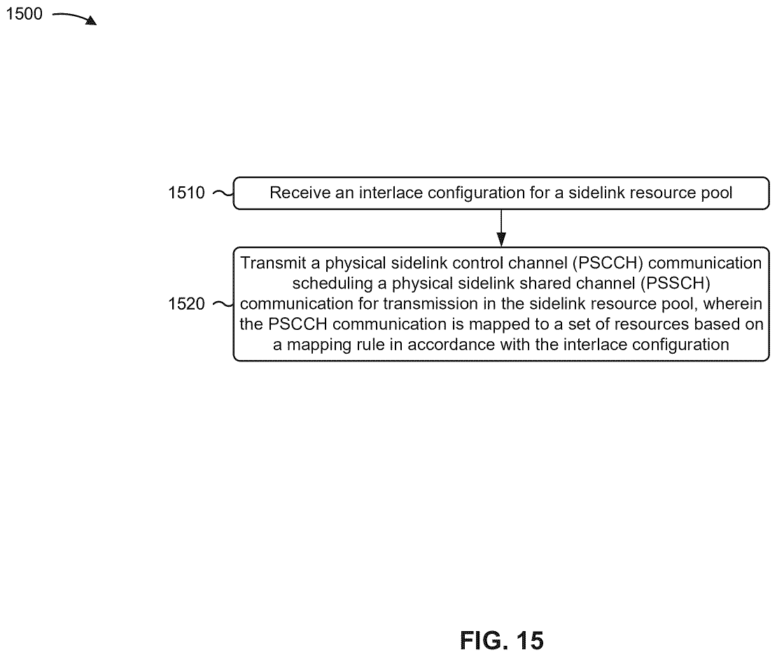

FIG. 15 is a flowchart of an example method 1500 of wireless communication. The method 1500 may be performed by, for example, a UE (e.g., UE 120).

Method 1500 begins at 1510 with receiving an interlace configuration for a sidelink resource pool. For example, the UE may receive an interlace configuration for a sidelink resource pool, as described above in connection with, for example, FIGS. 8 and 9, and at 1210 of FIG. 12.

Method 1500 then proceeds at 1520 with transmitting a PSCCH communication scheduling a PSSCH communication for transmission in the sidelink resource pool, wherein the PSCCH communication is mapped to a set of resources based on a mapping rule in accordance with the interlace configuration. For example, the UE may transmit a PSCCH communication scheduling a PSSCH communication for transmission in the sidelink resource pool, wherein the PSCCH communication is mapped to a set of resources based on a mapping rule in accordance with the interlace configuration, as described above in connection with, for example, FIGS. 8, 9, 10, 11, 13, 14, and at 1220 of FIG. 12. The set of resources may be included in the sidelink resource pool. For example, the set of resources may correspond to one or more interlaces defined by the interlace configuration. The PSCCH communication may be mapped based on the mapping rule, in that the PSCCH communication is mapped to the set of resources (e.g., RBs) in an order defined by the mapping rule.

In some aspects, the sidelink resource pool includes one or more RB sets, each RB set of the one or more RB sets is associated with one or more subchannels, and the method further comprises mapping, in accordance with the mapping rule, the PSCCH communication starting at an interlace index that corresponds to a subchannel, of the one or more subchannels, in which the PSSCH communication is scheduled.

In some aspects, the subchannel corresponds to multiple interlace indexes and wherein the interlace index is a lowest interlace index that corresponds to the subchannel.

In some aspects, the PSCCH communication is mapped to multiple interlace indexes, including the interlace index, that correspond to the subchannel in which the PSSCH communication is scheduled.

In some aspects, mapping the PSCCH communication further comprises mapping the PSCCH communication to increasing PRB indexes of a first interlace index of the multiple interlace indexes, and mapping the PSCCH communication to increasing PRB indexes of a second interlace index after mapping the PSCCH communication to the increasing PRB indexes of the first interlace index, wherein the second interlace index is larger than the first interlace index.

In some aspects, mapping the PSCCH communication further comprises mapping the PSCCH communication to increasing PRB indexes across all resource blocks corresponding to the multiple interlace indexes.

In some aspects, the one or more subchannels include a plurality of subchannels, and wherein the subchannel is a lowest subchannel of the plurality of subchannels.

In some aspects, the sidelink resource pool includes one or more RB sets, each RB set of the one or more RB sets is associated with one or more subchannels, and the method further comprises mapping, in accordance with the mapping rule, the PSCCH communication starting at an interlace index associated with a PRB index that corresponds to a subchannel, of the one or more subchannels, in which the PSSCH communication is scheduled.

In some aspects, the PSCCH communication is mapped to multiple interlace indexes that correspond to the subchannel in which the PSSCH communication is scheduled.

In some aspects, mapping the PSCCH communication further comprises mapping the PSCCH communication to increasing PRB indexes across all PRBs corresponding to the multiple interlace indexes.

In some aspects, mapping the PSCCH communication further comprises mapping the PSCCH communication to increasing PRB indexes of a first interlace index of the multiple interlace indexes, where the first interlace index is associated with a first starting PRB index, and mapping the PSCCH communication to increasing PRB indexes of a second interlace index of the multiple interlace indexes after mapping the PSCCH communication to the increasing PRB indexes of the first interlace index, wherein the second interlace index is associated with a second PRB index that is larger than the first starting PRB index.

In some aspects, the PRB index is a lowest PRB index, the one or more subchannels include multiple subchannels, and the subchannel in which the PSSCH communication is scheduled is a lowest subchannel of the multiple subchannels.

In some aspects, method 1500 includes receiving configuration information indicating a number of PRBs allocated to the PSCCH communication.

In some aspects, method 1500 includes mapping the number of PRBs of the PSCCH communication to increasing PRB indexes, corresponding to a subchannel of one or more subchannels in which the PSSCH communication is scheduled, starting from a lowest PRB index of the subchannel.

In some aspects, method 1500 includes mapping the number of PRBs of the PSCCH communication starting at a lowest PRB of an interlace index that corresponds to a subchannel of one or more subchannels in which the PSSCH communication is scheduled.

In some aspects, mapping the number of PRBs of the PSCCH communication further comprises first mapping the number of PRBs of the PSCCH communication to increasing PRB indexes of a first interlace index and then mapping a remainder of the number of PRBs of the PSCCH communication to increasing PRB indexes of a second interlace index, wherein the second interlace index is larger than the first interlace index.

In some aspects, the method further comprises mapping the number of PRBs of the PSCCH communication starting at an PRB of a first interlace index associated with a lowest PRB index that corresponds to a subchannel of one or more subchannels in which the PSSCH communication is scheduled.

In some aspects, mapping the number of PRBs of the PSSCH communication further comprises first mapping the number of PRBs of the PSCCH communication to increasing PRB indexes of a first interlace index associated with a lower starting PRB index and then mapping a remainder of the number of PRBs PSCCH communication to a second interlace index associated with a next higher starting PRB index that corresponds to the subchannel.

In some aspects, transmitting the PSCCH communication further comprises transmitting the PSCCH communication only if an interlace associated with the PSCCH communication can support at least the number of PRBs allocated to the PSCCH communication.

In some aspects, the number of PRBs is a first number of PRBs, an interlace associated with the PSCCH communication supports a second number of PRBs lower than the first number of PRBs, and the method further comprises mapping the PSCCH communication to the interlace using rate matching according to the second number of PRBs.

In some aspects, the number of PRBs is a first number of PRBs, an interlace associated with the PSCCH communication supports a second number of PRBs lower than the first number of PRBs, and the method further comprises mapping the PSCCH communication to the interlace using rate matching according to the first number of PRBs, wherein one or more PRBs of the PSCCH communication overlapping a guard band are punctured.

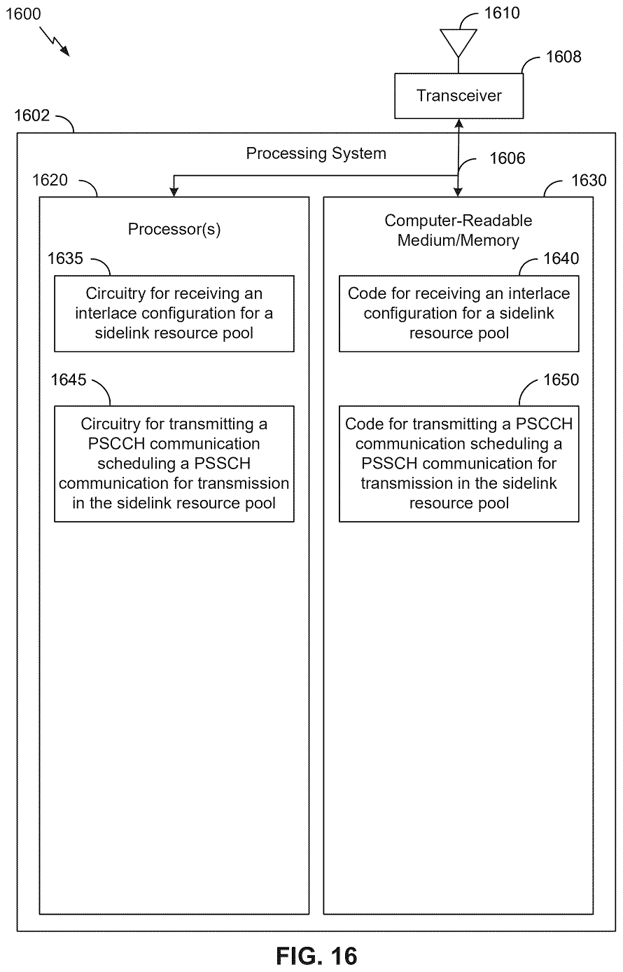

In one aspect, method 1500, or any aspect related to it, may be performed by an apparatus, such as communications device 1600 of FIG. 16, which includes various components operable, configured, or adapted to perform the method 1500. Communications device 1600 is described below in further detail.

Although FIG. 15 shows example blocks of method 1500, in some aspects, method 1500 may include additional blocks, fewer blocks, different blocks, or differently arranged blocks than those depicted in FIG. 15. Additionally, or alternatively, two or more of the blocks of method 1500 may be performed in parallel.

FIG. 16 is a diagram illustrating an example of an implementation of code and circuitry for a communications device 1600, in accordance with the present disclosure. The communications device 1600 may be a UE, or a UE may include the communications device 1600.

The communications device 1600 includes a processing system 1602 coupled to a transceiver 1608 (e.g., a transmitter and/or a receiver). The transceiver 1608 is configured to transmit and receive signals for the communications device 1600 via an antenna 1610, such as the various signals as described herein. The processing system 1602 may be configured to perform processing functions for the communications device 1600, including processing signals received and/or to be transmitted by the communications device 1600.

The processing system 1602 includes one or more processors 1620. In various aspects, the one or more processors 1620 may be representative of one or more of receive processor 258, transmit processor 264, TX MIMO processor 266, and/or controller/processor 280, as described with respect to FIG. 2. The one or more processors 1620 are coupled to a computer-readable medium/memory 1630 via a bus 1606. In various aspects, the computer-readable medium/memory 1630 may be representative of memory 282, as described with respect to FIG. 2. In certain aspects, the computer-readable medium/memory 1630 is configured to store instructions (e.g., computer-executable code, processor-executable code) that when executed by the one or more processors 1620, cause the one or more processors 1620 to perform the method 1500 described with respect to FIG. 15, or any aspect related to it. Note that reference to a processor performing a function of communications device 1600 may include one or more processors performing that function of communications device 1600.

As shown in FIG. 16, the communications device 1600 may include circuitry for receiving an interlace configuration for a sidelink resource pool (circuitry 1635).

As shown in FIG. 16, the communications device 1600 may include, stored in computer-readable medium/memory 1630, code for receiving an interlace configuration for a sidelink resource pool (code 1640).

As shown in FIG. 16, the communications device 1600 may include circuitry for transmitting a PSCCH communication scheduling a PSSCH communication for transmission in the sidelink resource pool (circuitry 1645).

As shown in FIG. 16, the communications device 1600 may include, stored in computer-readable medium/memory 1630, code for transmitting a PSCCH communication scheduling a PSSCH communication for transmission in the sidelink resource pool (code 1650).

Various components of the communications device 1600 may provide means for performing the method 1500 described with respect to FIG. 15, or any aspect related to it. For example, means for transmitting, sending, or outputting for transmission may include the transceiver(s) 254 and/or antenna(s) 252 of the UE 120 and/or transceiver 1608 and antenna 1610 of the communications device 1600 in FIG. 16. Means for receiving or obtaining may include the transceiver(s) 254 and/or antenna(s) 252 of the UE 120 and/or transceiver 1608 and antenna 1610 of the communications device 1600 in FIG. 16.

FIG. 16 is provided as an example. Other examples may differ from what is described in connection with FIG. 16.

The following provides an overview of some Aspects of the present disclosure:

Aspect 1: A method of wireless communication performed by a user equipment (UE), comprising: receiving an interlace configuration for a sidelink resource pool; and transmitting a physical sidelink control channel (PSCCH) communication scheduling a physical sidelink shared channel (PSSCH) communication for transmission in the sidelink resource pool, wherein the PSCCH communication is mapped to a set of resources based on a mapping rule in accordance with the interlace configuration.

Aspect 2: The method of Aspect 1, wherein the sidelink resource pool includes one or more resource block (RB) sets, each RB set of the one or more RB sets is associated with one or more subchannels, and the method further comprises mapping, in accordance with the mapping rule, the PSCCH communication starting at an interlace index that corresponds to a subchannel, of the one or more subchannels, in which the PSSCH communication is scheduled.

Aspect 3: The method of Aspect 2, wherein the subchannel corresponds to multiple interlace indexes and wherein the interlace index is a lowest interlace index that corresponds to the subchannel.

Aspect 4: The method of Aspect 2, wherein the PSCCH communication is mapped to multiple interlace indexes, including the interlace index, that correspond to the subchannel in which the PSSCH communication is scheduled.

Aspect 5: The method of Aspect 4, wherein mapping the PSCCH communication further comprises: mapping the PSCCH communication to increasing physical RB (PRB) indexes of a first interlace index of the multiple interlace indexes; and mapping the PSCCH communication to increasing PRB indexes of a second interlace index after mapping the PSCCH communication to the increasing PRB indexes of the first interlace index, wherein the second interlace index is larger than the first interlace index.

Aspect 6: The method of Aspect 4, wherein mapping the PSCCH communication further comprises mapping the PSCCH communication to increasing physical RB (PRB) indexes across all resource blocks corresponding to the multiple interlace indexes.

Aspect 7: The method of Aspect 2, wherein the one or more subchannels include a plurality of subchannels, and wherein the subchannel is a lowest subchannel of the plurality of subchannels.

Aspect 8: The method of any of Aspects 1-7, wherein the sidelink resource pool includes one or more resource block (RB) sets, each RB set of the one or more RB sets is associated with one or more subchannels, and the method further comprises mapping, in accordance with the mapping rule, the PSCCH communication starting at an interlace index associated with a physical RB (PRB) index that corresponds to a subchannel, of the one or more subchannels, in which the PSSCH communication is scheduled.

Aspect 9: The method of Aspect 8, wherein the PSCCH communication is mapped to multiple interlace indexes that correspond to the subchannel in which the PSSCH communication is scheduled.

Aspect 10: The method of Aspect 9, wherein mapping the PSCCH communication further comprises mapping the PSCCH communication to increasing PRB indexes across all PRBs corresponding to the multiple interlace indexes.

Aspect 11: The method of Aspect 9, wherein mapping the PSCCH communication further comprises: mapping the PSCCH communication to increasing PRB indexes of a first interlace index of the multiple interlace indexes, where the first interlace index is associated with a first starting PRB index; and mapping the PSCCH communication to increasing PRB indexes of a second interlace index of the multiple interlace indexes after mapping the PSCCH communication to the increasing PRB indexes of the first interlace index, wherein the second interlace index is associated with a second PRB index that is larger than the first starting PRB index.

Aspect 12: The method of Aspect 8, wherein the PRB index is a lowest PRB index, the one or more subchannels include multiple subchannels, and the subchannel in which the PSSCH communication is scheduled is a lowest subchannel of the multiple subchannels.

Aspect 13: The method of any of Aspects 1-12, further comprising receiving configuration information indicating a number of physical resource blocks (PRBs) allocated to the PSCCH communication.

Aspect 14: The method of Aspect 13, further comprising mapping the number of PRBs of the PSCCH communication to increasing PRB indexes, corresponding to a subchannel of one or more subchannels in which the PSSCH communication is scheduled, starting from a lowest PRB index of the subchannel.

Aspect 15: The method of Aspect 13, further comprising mapping the number of PRBs of the PSCCH communication starting at a lowest PRB of an interlace index that corresponds to a subchannel of one or more subchannels in which the PSSCH communication is scheduled.

Aspect 16: The method of Aspect 15, wherein mapping the number of PRBs of the PSCCH communication further comprises first mapping the number of PRBs of the PSCCH communication to increasing PRB indexes of a first interlace index and then mapping a remainder of the number of PRBs of the PSCCH communication to increasing PRB indexes of a second interlace index, wherein the second interlace index is larger than the first interlace index.

Aspect 17: The method of Aspect 13, wherein the method further comprises mapping the number of PRBs of the PSCCH communication starting at an PRB of a first interlace index associated with a lowest PRB index that corresponds to a subchannel of one or more subchannels in which the PSSCH communication is scheduled.

Aspect 18: The method of Aspect 17, wherein mapping the number of PRBs of the PSSCH communication further comprises first mapping the number of PRBs of the PSCCH communication to increasing PRB indexes of a first interlace index associated with a lower starting PRB index and then mapping a remainder of the number of PRBs PSCCH communication to a second interlace index associated with a next higher starting PRB index that corresponds to the subchannel.

Aspect 19: The method of Aspect 13, wherein transmitting the PSCCH communication further comprises transmitting the PSCCH communication only if an interlace associated with the PSCCH communication can support at least the number of PRBs allocated to the PSCCH communication.

Aspect 20: The method of Aspect 13, wherein the number of PRBs is a first number of PRBs, an interlace associated with the PSCCH communication supports a second number of PRBs lower than the first number of PRBs, and the method further comprises mapping the PSCCH communication to the interlace using rate matching according to the second number of PRBs.

Aspect 21: The method of Aspect 13, wherein the number of PRBs is a first number of PRBs, an interlace associated with the PSCCH communication supports a second number of PRBs lower than the first number of PRBs, and the method further comprises mapping the PSCCH communication to the interlace using rate matching according to the first number of PRBs, wherein one or more PRBs of the PSCCH communication overlapping a guard band are punctured.

Aspect 22: An apparatus for wireless communication at a device, comprising a processor; memory coupled with the processor; and instructions stored in the memory and executable by the processor to cause the apparatus to perform the method of one or more of Aspects 1-21.

Aspect 23: A device for wireless communication, comprising a memory and one or more processors coupled to the memory, the one or more processors configured to perform the method of one or more of Aspects 1-21.

Aspect 24: An apparatus for wireless communication, comprising at least one means for performing the method of one or more of Aspects 1-21.

Aspect 25: A non-transitory computer-readable medium storing code for wireless communication, the code comprising instructions executable by a processor to perform the method of one or more of Aspects 1-21.

Aspect 26: A non-transitory computer-readable medium storing a set of instructions for wireless communication, the set of instructions comprising one or more instructions that, when executed by one or more processors of a device, cause the device to perform the method of one or more of Aspects 1-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A user equipment (UE) for wireless communication, comprising:
one or more memories; and
one or more processors, coupled to the one or more memories, configured to cause the UE to:
receive an interlace configuration for a sidelink resource pool; and
transmit a physical sidelink control channel (PSCCH) communication scheduling a physical sidelink shared channel (PSSCH) communication for transmission in the sidelink resource pool, wherein the PSCCH communication is mapped to a set of resources based on a mapping rule in accordance with the interlace configuration.

2. The UE of claim 1, wherein the sidelink resource pool includes one or more resource block (RB) sets, each RB set of the one or more RB sets is associated with one or more subchannels, and the one or more processors are configured to cause the UE to map, in accordance with the mapping rule, the PSCCH communication starting at an interlace index that corresponds to a subchannel, of the one or more subchannels, in which the PSSCH communication is scheduled.

3. The UE of claim 2, wherein the subchannel corresponds to multiple interlace indexes and wherein the interlace index is a lowest interlace index that corresponds to the subchannel.

4. The UE of claim 2, wherein the PSCCH communication is mapped to multiple interlace indexes, including the interlace index, that correspond to the subchannel in which the PSSCH communication is scheduled.

5. The UE of claim 4, wherein the one or more processors, to cause the UE to map the PSCCH communication, are configured to cause the UE to:
map the PSCCH communication to increasing physical RB (PRB) indexes of a first interlace index of the multiple interlace indexes; and
map the PSCCH communication to increasing PRB indexes of a second interlace index after mapping the PSCCH communication to the increasing PRB indexes of the first interlace index, wherein the second interlace index is larger than the first interlace index.

6. The UE of claim 4, wherein the one or more processors, to cause the UE to map the PSCCH communication, are configured to cause the UE to map the PSCCH communication to increasing physical RB (PRB) indexes across all resource blocks corresponding to the multiple interlace indexes.

7. The UE of claim 2, wherein the one or more subchannels include a plurality of subchannels, and wherein the subchannel is a lowest subchannel of the plurality of subchannels.

8. The UE of claim 1, wherein the sidelink resource pool includes one or more resource block (RB) sets, each RB set of the one or more RB sets is associated with one or more subchannels, and the one or more processors are configured to cause the UE to map, in accordance with the mapping rule, the PSCCH communication starting at an interlace index associated with a physical RB (PRB) index that corresponds to a subchannel, of the one or more subchannels, in which the PSSCH communication is scheduled.

9. The UE of claim 8, wherein the PSCCH communication is mapped to multiple interlace indexes that correspond to the subchannel in which the PSSCH communication is scheduled.

10. (canceled)

11. The UE of claim 9, wherein the one or more processors, to cause the UE to map the PSCCH communication, are configured to cause the UE to:
map the PSCCH communication to increasing PRB indexes across all PRBs corresponding to the multiple interlace indexes; or
map the PSCCH communication to increasing PRB indexes of a first interlace index of the multiple interlace indexes, where the first interlace index is associated with a first starting PRB index, and
map the PSCCH communication to increasing PRB indexes of a second interlace index of the multiple interlace indexes after mapping the PSCCH communication to the increasing PRB indexes of the first interlace index, wherein the second interlace index is associated with a second PRB index that is larger than the first starting PRB index.

12. The UE of claim 8, wherein the PRB index is a lowest PRB index, the one or more subchannels include multiple subchannels, and the subchannel in which the PSSCH communication is scheduled is a lowest subchannel of the multiple subchannels.

13. The UE of claim 1, wherein the one or more processors are further configured to receive configuration information indicating a number of physical resource blocks (PRBs) allocated to the PSCCH communication.

14. The UE of claim 13, wherein the one or more processors are further configured to cause the UE to map the number of PRBs of the PSCCH communication to increasing PRB indexes, corresponding to a subchannel of one or more subchannels in which the PSSCH communication is scheduled, starting from a lowest PRB index of the subchannel.

15. The UE of claim 13, wherein the one or more processors are further configured to cause the UE to map the number of PRBs of the PSCCH communication starting at a lowest PRB of an interlace index that corresponds to a subchannel of one or more subchannels in which the PSSCH communication is scheduled.

16. The UE of claim 15, wherein the one or more processors, to cause the UE to map the number of PRBs of the PSCCH communication, are configured to cause the UE to first map the number of PRBs of the PSCCH communication to increasing PRB indexes of a first interlace index and then map a remainder of the number of PRBs of the PSCCH communication to increasing PRB indexes of a second interlace index, wherein the second interlace index is larger than the first interlace index.

17. The UE of claim 13, wherein the one or more processors are configured to cause the UE to map the number of PRBs of the PSCCH communication starting at an PRB of a first interlace index associated with a lowest PRB index that corresponds to a subchannel of one or more subchannels in which the PSSCH communication is scheduled.

18. The UE of claim 17, wherein the one or more processors, to cause the UE to map the number of PRBs of the PSSCH communication, are configured to cause the UE to first map the number of PRBs of the PSCCH communication to increasing PRB indexes of a first interlace index associated with a lower starting PRB index and then map a remainder of the number of PRBs PSCCH communication to a second interlace index associated with a next higher starting PRB index that corresponds to the subchannel.

19. The UE of claim 13, wherein the one or more processors, to cause the UE to transmit the PSCCH communication, are configured to cause the UE to transmit the PSCCH communication only if an interlace associated with the PSCCH communication can support at least the number of PRBs allocated to the PSCCH communication.

20. The UE of claim 13, wherein:
the number of PRBs is a first number of PRBs,
an interlace associated with the PSCCH communication supports a second number of PRBs lower than the first number of PRBs, and
the one or more processors are configured to cause the UE to:
map the PSCCH communication to the interlace using rate matching according to the second number of PRBs, or
to map the PSCCH communication to the interlace using rate matching according to the first number of PRBs, wherein one or more PRBs of the PSCCH communication overlapping a guard band are punctured.

21. (canceled)

22. A method of wireless communication performed by a user equipment (UE), comprising:
receiving an interlace configuration for a sidelink resource pool; and
transmitting a physical sidelink control channel (PSCCH) communication scheduling a physical sidelink shared channel (PSSCH) communication for transmission in the sidelink resource pool, wherein the PSCCH communication is mapped to a set of resources based on a mapping rule in accordance with the interlace configuration.

23. (canceled)

24. (canceled)
